(19) United States
(12) Patent Application Publication
(10) Pub. No.: US 2021/0125626 A1
(43) Pub. Date: Apr. 29, 2021

(54) Method and Application for Synchronizing Audio Across a Plurality of Devices

(71) Applicant: Brad Schwan, Sausalito, CA (US)

(72) Inventor: Brad Schwan, Sausalito, CA (US)

(21) Appl. No.: 17/079,798

(22) Filed: Oct. 26, 2020

Related U.S. Application Data
(60) Provisional application No. 62/925,954, filed on Oct. 25, 2019.

(51) Int. Cl. G10L 21/0356; G09B 19/06; G09B 7/02

(52) U.S. Cl. CPC G10L 21/0356; G10H 2240/325; G09B 7/02; G09B 19/06

(57) ABSTRACT

A method and associated software application (“app”) for synchronizing audio across a plurality of mobile devices such as smart phones. In some implementations, the method syncs all the smart phones together allowing users to use the headsets on the smart phones instead of having to use speakers. In some implementations, the application syncs the audio by first downloading the audio onto the smart phones and then syncing it across the smart phones by using in conjunction, the clock on the smart phone, the clock on a server and/or the time obtained from GPS satellites.

### CROSS REFERENCE TO RELATED APPLICATIONS

The present application claims the benefit of the filing date of U.S. Provisional Patent Application Ser. No. 62/925,954, filed Oct. 25, 2019. The foregoing application is incorporated by reference in its entirety as if fully set forth herein.

### TECHNICAL FIELD

The present invention relates generally to software applications (“apps”) for mobile devices such as smart phones, and more particularly to an improved method and application for synchronizing audio across a plurality of mobile devices.

### SUMMARY

Described herein is an improved method and associated software application (“app”) for synchronizing audio across a plurality of mobile devices such as smart phones. In some implementations, the method syncs all the smart phones together allowing users to use the headsets on the smart phones instead of having to use speakers.

In some implementations, the application syncs the audio by first downloading the audio onto the smart phones and then syncing it across the smart phones by using in conjunction, the clock on the smart phone, the clock on a server and/or the time obtained from GPS satellites.

Particular embodiments of the subject matter described in this specification can be implemented so as to realize one or more of the following advantages.

In some implementations, the method and app syncs audio across smart phones allowing people to dance using the app, their phone and a pair of headphones to dance without disturbing the environment around them.

In some implementations, the method and app may be used for teaching multi level classes where there are beginners through advanced students taking a class at the same time.

In some implementations, the method and app may be used for teaching yoga.

In some implementations, the method and app can be used to create “Participatory Theater” or “Role Play Theater” where instead of going to a theater production and watching a play, the users each wear loose fitting ear buds and hear their lines, stage direction and inner thoughts through the headsets.

In some implementations, the method and app can be used to learn a new language by first performing a play in a user's native language, and then again in a foreign language that the user is learning.

In some implementations, the method and app can be used in this way as a cultural integration tool.

In some implementations, the method and app can be used for role play in therapy sessions.

In some implementations, the method and app can be used in protest marches in a call and response fashion where the marchers would hear a phrase and then they would all repeat it in unison.

In some implementations, the method and app can be used to sync fans at sporting events allowing them to do chants on both sides of the event.

In some implementations, the method and app can be used for teaching multi level classes where there are beginners through advanced students taking a class at the same time. In some implementations, this is implemented as yoga instruction.

In some implementations, the method and app can be used for informational tours.

In some implementations, the method and app can be used to sync multiple tracks in several languages simultaneously.

In some implementations, the method and app can be used to facilitate participation in worldwide events with multiple events happening all around the world at the same time.

In some implementations, religious groups could use the method and app to convey prayers or other messages.

In some implementations, the method and app may be used for doing multiple person Karaoke that could include instruments and harmonies.

In some implementations, the method and app may be used for storytelling applications.

It is therefore an object of the present invention to provide a new and improved method and associated software application (“app”) for synchronizing audio across a plurality of mobile devices.

It is another object of the present invention to provide a new and improved application that enables smart phones to be used instead of speakers.

The details of one or more embodiments of the subject matter described in this specification are set forth in the description below. Other features, aspects, and advantages of the subject matter will become apparent from the description, the attachments, and the claims.

Those skilled in the art will appreciate that the conception upon which this disclosure is based readily may be utilized as a basis for the designing of other structures, methods and systems that include one or more of the various features described below.

Certain terminology and derivations thereof may be used in the following description for convenience in reference only, and will not be limiting. For example, references in the singular tense include the plural, and vice versa, unless otherwise noted.

### BRIEF DESCRIPTION OF THE DRAWINGS

FIG. 1 is a view of one example of a dance implementation of the method and application;

FIG. 2 is a view of one example of a yoga implementation of the method and application;

FIG. 3 is a view of one example of a participatory theater implementation of the method and application;

FIG. 4 is a view of one example of a device that may be used for a storytelling implementation of the method and application; and

FIG. 5 is a view of one example of a storytelling implementation of the method and application.

### DETAILED DESCRIPTION

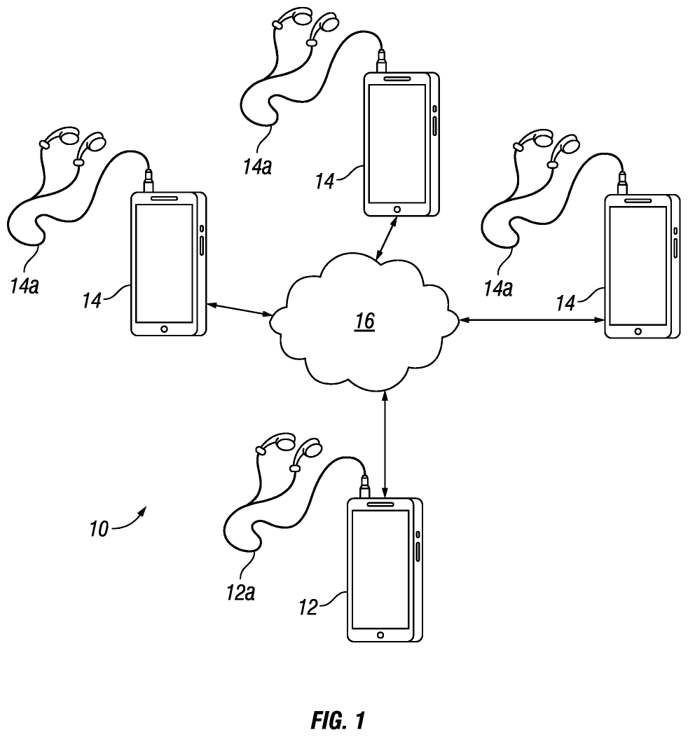

FIG. 1 is a view of one example of a dance implementation 10 of the method and application, illustrating a leader phone 12 with headset 12a, a plurality of user phones 14 with headsets 14a, all connected via wifi or cellular data to cloud/server 16.

In some implementations, the mobile app syncs audio across smart phones allowing people to dance using the app, their phone and a pair of headphones to dance without disturbing the environment around them. The leader creates an event on the app on leader phone 12. Participants join the event, and the leader presses the play button and everyone that signed up for the event hears the music at the same time, and at the same beat, on user phones 14. Participants use the headsets 14a attached to their phones to dance in nature without disturbing the surroundings.

Dance fitness is moving in natural freeform ways. Classes can beheld outside in parks, at beaches, in backyards, in a meadow or almost anywhere. Classes can be for all levels simultaneously, enabling dancers to move to their own level of ability putting in as much or as little effort as their abilities allow. The mobile app syncs the audio across the smart phones so that everyone hears the music to the same beat.

In some implementations, dance leaders may organize events as a business. The app allows dance leaders to charge for events from the mobile app. Participants may pay for the event using a credit card when they sign up for the event.

In some implementations, the app may be used for dance instruction (e.g., he hears “step forward”, she hears “step back”, while both hear the same music at the same beat).

In some implementations, the app may work with music streaming sources. For example, someone with a music streaming account chooses a playlist to use. The server then plays the playlist and records it, and the recording then gets used to create an event. People join the event and the dance leader starts the event as usual with lots of people that don't have a music streaming accounts dancing to the music.

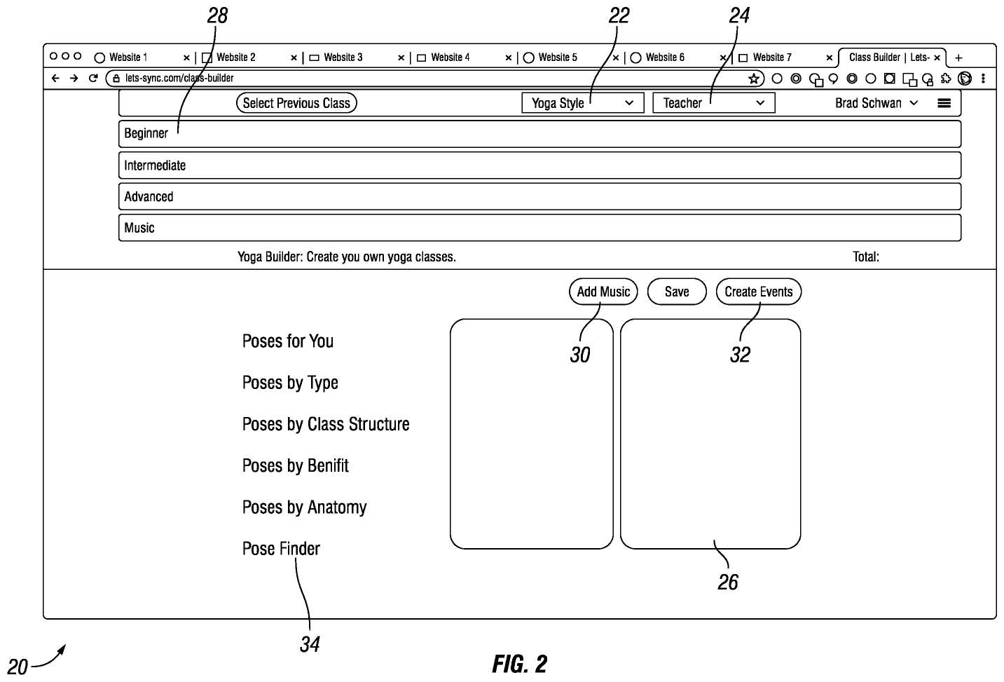

In some implementations, the app may be used for teaching multi level classes where there are beginners through advanced students taking a class at the same time. For example, FIG. 2 is a view of one example of a yoga implementation of the method and application, showing one implementation of a yoga class builder website template 20, where the user may select a style of yoga at yoga style menu 22, select a teacher at teacher menu 24, generate a list of asanas at asana list 26, populate timelines for different skill levels at timelines 28, add music at add music tab 30, and create an event at create events tab 32. Poses information and examples may be accessed at poses list 34.

In some implementations, teachers or people wanting to do their own yoga practice can go to the website and choose asanas from filtered lists. The audio instructions for doing this asana are added to a timeline. The timeline has three levels for each asana; Beginner, Intermediate, and Advanced. The teacher or solo practitioner chooses asanas one at a time and builds a whole class this way. The computer makes suggestions on what asana might be good to follow the one before and suggests transitions when needed. The builder adds already recorded class instruction and builds a custom class out of asanas that then can be played back for personal use or for a class.

In some implementations, once a class is created using the builder, the app is used to create an event. Once the event is created other people join the event. When the teacher presses start on their phone the class starts.

In some implementations, the yoga class is built by combining audio descriptions of how to do the pose with transitions to the next pose in the sequence.

In some implementations, the app syncs the audio. Having it sync allows for some additions to a class, like being able to do om's, singing together, and breathing together.

Being able to teach multi levels of skill classes addresses a very common problem with teaching yoga classes. Having mixed skills in a class inevitably diminishes the experience and learning for the more advanced students. Trying to teach a more advanced class with beginners in the class also leads to beginners trying to do more than they are capable of and can lead to frustration and or injuries.

In some implementations, the method enables classes to be performed outside without everyone needing to be facing the teacher. This is a distinct advantage, as now yoga can be taught with students placed in every direction and with a greater distance apart. Now classes could be taught with everyone facing beautiful scenery or with students secluded with plants and other separators between them.

Yoga using earbuds increases a practitioner's ability to go deeper into meditation. In addition, yoga using earbuds with noise cancellation can make even noisy places peaceful.

The method enables different skill levels of instruction to happen at the same time. This allows for classes to be combined. No longer do classes have to be for beginners or only for advanced students allowing for a better experience for the practitioners and larger classes for the teacher.

Students can design their own classes and work on the asanas that they need most. The method and app enable a user to build a custom class by combining asanas. Someone can create a class and share the experience with friends whether they are in close proximity or not. Because the classes are synced, the participants feel connected and can see that they are all doing the class together even if they only hear what is in their headset.

Classes can be ongoing with no set start time. Students could come to a location, create their own class or choose one that the teacher created and start their practice any time and the teacher could offer personalized help where needed, basically eliminating the class schedule.

For example, a yoga class may be lead by an instructor, with audio instructions given through the app. The instructor demonstrates the postures at different levels of difficulty while the app explains the posture in more detail relative to the person's skill level. The instructor then can go around the room and help students individually. The instructor may return to the front of the room from time to time when a new posture is needed to be demonstrated. As another example, the instructor may first quickly explain all the postures in a flow and then as the app takes people through the flow the instructor can walk around through the room and adjust everyone.

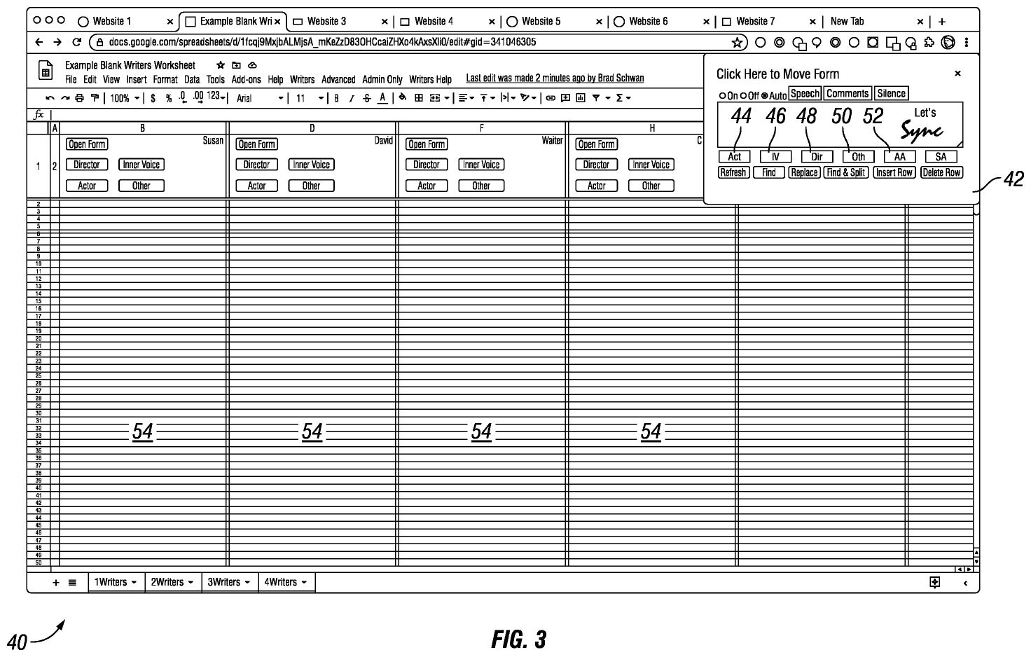

FIG. 3 is a view of one example of a participatory theater implementation of the method and application, showing one implementation of a writer's worksheet website template 40, illustrating script entry window 42 including actor's voice tab 44, inner voice tab 46, director's voice tab 48, “other” tab 50, auxiliary character (e.g., small part, no physical presence) tab 52, and other tabs as appropriate. These various types of script entries may be sequentially displayed for each actor at actor columns 54. This enables the writer(s) to create synched, multi-track audio where each character hears (and then repeats) their spoken lines, but they also hear an inner voice (heard only by them), stage directions from the director, and the like.

In some implementations, each square in the spreadsheet denotes time, e.g., the time it takes to hear or say a line, such that each square in each row is approximately the same length when spoken.

In some implementations, this enables the method and app to be used to create “Participatory Theater” or “Role Play Theater” where instead of going to a theater production and watching a play, the users each wear loose fitting ear buds and hear their lines, stage direction and inner thoughts through the headsets. The app has the ability to sync multiple playlists at the same time allowing people to become actors in their own theater production. Each actor plays a character in the play without first knowing how the play will unfold.

In some implementations, an app for writing scripts for plays works like a giant texting machine, with each writer writing for their own character.

In some implementations, the app and corresponding writer's script instructions may be used for writing for virtual reality applications.

In some implementations, the app may be used with foreign language plays to learn a new language. Similar to the theater production described above, this would be used to learn a new language by first performing the play in a user's native language and then again in the foreign language that they are learning.

In some implementations, the app can be used as a cultural integration tool, such as for people emigrating to a new country and culture. This tool would be wonderful for people coming from vastly different cultures and needing to assimilate into new cultures. By being actors in the plays they could learn how to interact in a socially correct way in their new culture.

In some implementations, the app could be used for role play in therapy sessions. For example, a couple that was having a hard time understanding the experience of the other partner could play the opposite sex in a role play theater designed to let them experience what it is like to be the other person in their relationship. This could be designed by psychologists to be used in therapy sessions.

In some implementations, the app could be used in protest marches in a call and response fashion where the marchers would hear a phrase and then they would all repeat it in unison. This allows for more complex messages to be used than simply chanting the same thing over and over. The app could also be used to play music for the marchers so they can all dance to the same beat or walk in step as well.

In some implementations, the app could be used to sync fans at sporting events allowing them to do chants on both sides of the event. For example, a call and response could be used that was planned for both team's fans with one team chanting Go Grizzlies and the other side then chanting Go Bobcats. This could also be used in bars or venues where sporting events are being watched.

In some implementations, the app may be used for informational tours. For example, where a tourist is visiting a city or a museum the app can be used to walk a group or an individual through a place and explain interesting aspects of the location to the listeners. Since the app can sync multiple tracks at the same time many of the uses could be done in several languages simultaneously. This applies to all of the other uses as well.

In some implementations, the app can be used to sync multiple tracks in several languages simultaneously.

In some implementations, the app could be used to facilitate participation in worldwide events with multiple events happening all around the world at the same time.

In some implementations, religious groups could use the app to convey prayers or other messages. For example, Muslims could get a teaching or prayer from the Imam at the time of performing Salat five times a day. Other religious groups could similarly use it as well in one form or another.

In some implementations, the app may be used for doing multiple person Karaoke that could include instruments and harmonies. Imagine hearing in your headset a beat. You mimic this beat on a drum. The person next to you hears a simple tune on a xylophone and mimics it The person next to them hears a person singing words in one pitch of a harmony, this person reads the words on their phone and sings them matching the pitch. The person next to them does the same thing but only with a different pitch. As a result, four people are now creating complex music.

In some implementations, this technology may add in video. This could be used to demonstrate yoga postures, give lines for karaoke, or other kinds of instructions.

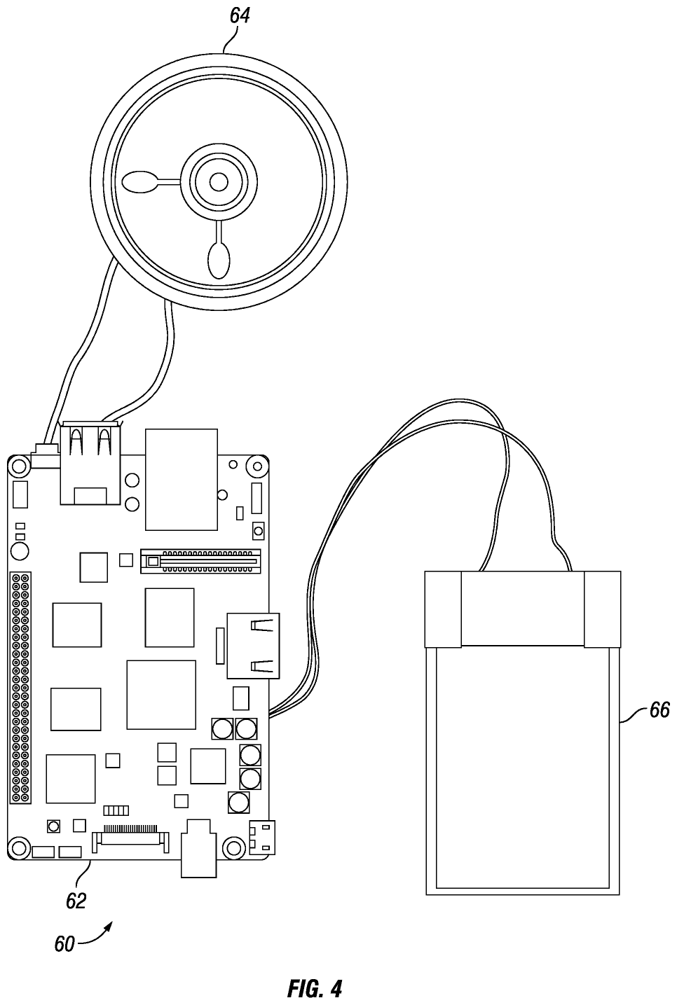

FIG. 4 is a view of one example of a device 60 that may be used for a storytelling implementation of the method and application. In some implementations, device 60 is essentially a barebones smart phone (not needing a screen) including a smart phone board 62 connected to a speaker 64, and powered by a battery 66. The device is small and easily fits into a stuffed animal, doll, or other article, preferably in the head so that the body of the article stays soft.

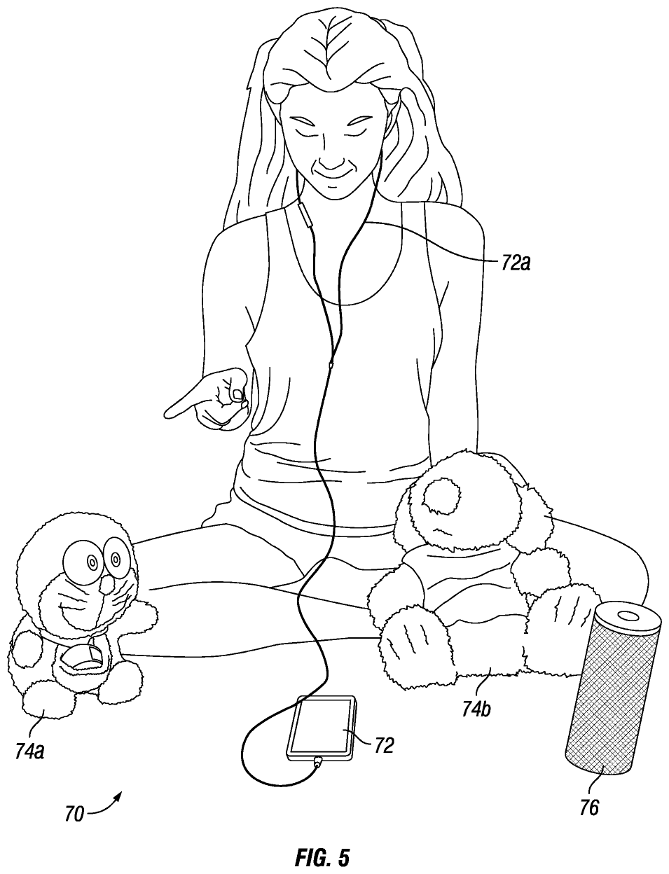

FIG. 5 is a view of one example of a storytelling implementation 70 of the method and application, illustrating a user's smart phone 72 with the downloaded app, associated earbuds 72a, one or more stuffed animals 74a, 74b each with integrated devices 60, and a separate director's device 76 which may include a charger for the other devices. In some implementations, the user's phone 72 may serve as the master control, including start, play, pause, etc.

In some implementations, the method and app syncs storytelling audio across a user's smart phone, one or more stuffed animals each with integrated devices to receive discrete scripted audio, and a separate director's device to receive discrete scripted audio.

Accordingly, in some implementations, the method and application can be in the form of synced talking stuffed animals or dolls. For example, put a small Bluetooth speaker inside stuffed animals or make a pouch that a cell phone can fit into, and connect a cell phone via Bluetooth to the stuffed animal's speaker or open the app on the phone and slip it into a pouch inside the stuffed animal Multiple phones will be needed, one for each animal Each phone is then synced with different audio tracks using the app. Each stuffed animal then speaks a story together.

For example, stuffed animal 74a may say “Good Morning”, then stuffed animal 74b responds “Thank you, and Good Morning to you” and the story unfolds. Parents could make their own stories or use stories out of the library.

In some implementations, Bluetooth commands are synced with the story and the stuffed animals/dolls could be animated. In this iteration the stuffed animals/dolls are built especially for this purpose. Phones connect both to the speaker and to the controller in the doll. The controller operates any mechanical movements of the stuffed animal/doll with commands given from the app on the phone to the controller.

In some implementations, there is a USB charging station which the animal's devices plug into to charge at night.

In some implementations, a parent on their phone creates an event and chooses what story the child or children will listen to. Then when the stuffed animals are turned on they automatically search for an event created by the parent using the email credentials. The device then automatically downloads the story and prepares the device to play.

In some implementations, on the parent's phone when the devices have joined the event, it can be seen. When all the stuffed animals that are in the story have joined the event the parent presses start on their phone, and the story begins.

Each animal speaking in turn tells a story like they were real people. In some implementations, the speaker in the separate device 76 plays sound effects and the voices of characters that are not represented by stuffed animals.

In some implementations, the child and or several children or parents may wear earbuds, and become characters in the story, so that when it is their turn to speak they hear the words first in their headset and then they repeat the words aloud so the other characters can hear them.

In some implementations, this method and app can be used at Halloween in pumpkins to tell scary stories to passers-by or to animate almost any object. In other implementations, the method and app can be used to animate articles used in other holidays or events.

In some implementations, parents or children can write their own stories for the animals using the participatory theater writer's worksheet described above.

In some implementations, the event is first created by the parent, and the device then goes via wifi onto the internet and joins the event. Once the stuffed animals/dolls have joined the event the parent can start the event and the audio is heard on the device.

In some implementations, part of the app transfers the wifi credentials, parent's email address, and any other needed bits of information to the stuffed animals so that they all work together. In some implementations, Bluetooth is used only to transfer the needed information. Once the stuffed animal has the needed credentials it will work over the internet via wifi. This way a parent and start a story event and then leave and the story will still continue for the child.

In some implementations, the device connects at first to a phone running the app via Bluetooth Low Energy (BLE). It transfers wifi information and an identification code to the device. After this the device will work anywhere there is wifi and does not need to be connected again via BLE. The device will automatically join an event created on the phone just by turning on the device. The phone no longer needs to be present. All the devices will continue to play the audio in sync.

In some implementations, participants can plug headphones into the back of the stuffed animals, hear lines, and repeat them aloud. In some implementations, they also may hear the inner thoughts, history, and/or motivations for the character.

Disclosed below are some implementations of processes that may be used to sync iOS and Android smartphones.

Smartphones all have different latency when they get a signal to start playing and when the person actually hears the audio. For example, phones all have different playback speeds due to processor speed and efficiency of hardware/software. For better quality of sound, some implementations use a different syncing technique on iPhones than on Androids.

Bluetooth headsets have different latency from when they receive the Bluetooth signal and when a person hears the audio depending on the quality and age of the headset.

Internet speed varies across networks and legs of a connection. For example, a plurality of phones are all getting time from the server to keep the music in sync. Sometimes times are off due to varying speeds between the phone and the server.

Sometimes there are lags in internet connections. Internet service can actually stop for some legs of an internet connection for a short period of time, and this is especially true for cellular data internet. If a leaders phone gives a command, we have a feed back system that checks to make sure all the phones and the server received the command, otherwise we repeat the commands until we get a response from each phone or from the server. For example, I am the leader phone and I give a command to pause the audio. This command goes to the server. If the server does not send back a signal saying it got the command, we send the command again from the leader's phone. The Server then sends out the command to the phones, and it keeps sending the command until all the phones have sent back a message saying they received the command Some phones might not get the command because they are not getting internet at that moment.

There can be a difference between playing music in the foreground and the background, e.g., when the phone is in Lock mode.

iOS App Time Synchronization: For synchronization of the App time with the App Web Server time, iOS App uses the framework «Kronos».

«Kronos»—NTP (Network Time Protocol) client library (https://cocoapods.org/pods/Kronos)

License: «Kronos» is maintained by Lyft and released under the Apache 2.0 license.

«Kronos» gets time from time.apple.com server.

WebSocket

For messaging the App with the App Web Server in real time, iOS App uses the framework «Starscream».

«Starscream»—WebSocket Protocol client library

(https://cocoapods.org/pods/Starscream)

Licence: «Starscream» is licensed under the Apache v2 License.

«Starscream» used for real-time messaging between the App and the App Web Server.

The App connect to App Web Server via WebSocket(«Starscream»).

On each client socket message server should send confirm message back, otherwise the App should send messages again until they will be delivered.

After joining to event, user goes to Event Room Screen. The App send JoinToEvent message. From WebSocket the App get event status messages, to be notified when event started/ended. On EventStart message user will be promoted that event started and available to join into any downloaded playlist.

The App send JoinPlaylist message to notify App Web Server when user want to join to specific playlist. On server response the App goes into Player Screen.

On Player Screen using NTP client («Kronos») the App get time as on App Web Server. PlayerStatus message includes info for syncing the app player with App Web Server virtual player progress:

1. player current track position (serverTrackPosition)

2. server time stamp (serverTimeStamp)

To get message ping delay (pingDelay) we need to compare current App time (appTime) with playerStatus server time stamp (serverTimeStamp) “pingDelay=appTime−serverTimeStamp”

Now we need get real time track position (realTimeTrackPosition) common for all users joined to this playlist, so we need remove pingDelay from message.

“realTimeTrackPosition=serverTrackPosition−pingDelay”

Synchronization Iteration Frequency

The App sends requests for PlayerStatus message on each synchronization check point for synchronization.

Synchronization check point needed for synchronization players at same time, to do so we calculate appropriate time to send synchronization requests to App Web Server (delayToNextSyncCheckPoint).

Frequency of check points for synchronization depends on realTimeTrackPosition. We use 20 seconds (timeBetweenCheckPoints) from one synchronization check point to another as default.

delayToNextSyncCheckPoint can't be less then 14 sec. otherwise App sends request message on next synchronization check point iteration.

App get remainder by timeBetweenCheckPoints to get passed time from last synchronization check point (timeAfterLastSyncCheckPoint).

“timeAfterLastSyncCheckPoint=realTimeTrackPosition % timeBetweenCheckPoints”

Now we can calculate how much time left to next synchronization checkPoint (delayToNextSyncCheckPoint).

“delayToNextSyncCheckPoint=timeBetweenCheckPoints−timeAfterLastSyncCheckPoint”

The App will send synchronization message in delayToNextSyncCheckPoint seconds from current App time.

Player Synchronization

App use AVAudioPlayer.

AVAudioPlayer—an audio player that provides playback of audio data from a file or memory.

AVAudioPlayer a part of AVFoundation Framework provided from Apple to use.

For player synchronization used 2 players. One on foreground which are hear user, and the second one is used for muted rewind. And when second player end his rewind work, app remove first player and will unmute second player. So users will not hear any rewind work, and only can detect moment on which second player will be switched to main player.

App player get realTimeTrackPosition for synchronization.

For iOS App there are difference between playing music on foreground or background. We use default offset constant in background mode (bacgroundLatencyDefault) of 0.05 sec.

The App used permanent constant (sync ToAndroidLatencyDefault) to be in sync with Android of 0.1 sec.

The App use manual calibration offset latency for bluetooth headset (calibrationBluetoothLatency) as well.

“allOffsets=bacgroundLatencyDefault+syncToAndroidLatencyDefault+calibrationBluetoothLatency»

For player synchronization used time at which server track was started (serverTrackStartedAtTime).

“serverTrackStartedAtTime=serverTimeStamp−serverTrackPosition”
“serverTrackStartedAtTimeWithAllOffsets=serverTrackStartedAtTime−allOffsets»

HardRewind Step

“appTrackStartedAt=appTime−appPlayerState”

Now we can calculate difference between app player track state and server track state

“diff=appTrackStartedAt−serverTrackStartedAtTimeWithAllOffsets»

If diff more than 0.049 sec app set new trackState directly (hard rewind). Then app wait 0.5 sec to let player finish any needed work and be ready for next step.

SoftRewind Step

After that we again check what secondPlayer appTrackStartedAt and serverTrackStartedAtTimeWithAllOffsets and get difference between them

“appTrackStartedAt=appTime—appPlayerState”
“diff=appTrackStartedAt—serverTrackStartedAtTimeWithAllOffsets»

If diff more than 0.005 sec we start softRewind step.

softRewind based on changing player speed rate. We need calculate which speed needed to get player to synchronization, as default app use 0.4 sec of softRewind duration (syncDuration).
syncRatePerSecond=diff/syncDuration

After syncDuration time, App need to set player speed rate to normal player speed (1.0), and now player are synchronized.

Final Synchronization Step

When synchronization ends, App switch main player to second synched player and turn Volume ON.

Android Time Synchronization: the main difference is that iOS uses two players where this is not possible on the Android phones.

The concept of synchronization is based on the interaction of the client server through the web socket. The principle of operation is that the application first connects to the atomic clock server (TrueTime), downloads the media it needs, then creates a stable connection with the socket by means of cyclic confirmation and creates a bind player service (Exoplayer) working in the foreground. The player has its own user interface, each command of which is executed by means of data transmission to the server and their reverse confirmation. The player's work is based on the processing of a local media file using information from the server, i.e. with an interval of 1 second, the player looks at the status of server playback and then makes a decision to synchronize the track. The synchronization state depends on several factors, if we are more than 250 ms behind the server, it is relevant, otherwise we will either speed up or slow down the reproduction in percentage terms. Synchronization also takes into account the difference in atomic time of the client and server, the difference in the initialization of sending a message and its end, as well as the difference in processing the rewind function inside the player. In total, the whole difference gives us a general idea of the current state of server playback, thereby allowing us to perform the most accurate (0-150 ms) synchronization rewind to the server playback point.

In some implementations, it may be possible to measure how fast or slow the player is on each phone under normal CPU load. Then before downloading the music to the phone we stretch or shrink the music and adjust the time markers so that each phone will be closer to playing at the same time before doing any adjustments at the phone level. Basically adding in one more step before doing all the syncing that happens on the phone now. This may further improve the sound quality.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method and software application for synchronizing audio across a plurality of mobile devices comprising:
downloading the audio onto the mobile devices and then syncing it across the mobile devices by using in conjunction one or more of the clock on the mobile device, the clock on a server and the time obtained from GPS satellites.

2. The method and application of claim 1 wherein the app syncs audio across smart phones allowing people to dance using the app, their phone and a pair of headphones to dance without disturbing the environment around them.

3. The method and application of claim 1 wherein the app syncs yoga instructions across a plurality of smart phones.

4. The method and application of claim 3 wherein the app syncs yoga instructions from a yoga class builder website template, where the user selects a style of yoga, a teacher, a list of asanas, and adds music to create an event.

5. The method and application of claim 1 wherein the app syncs participatory theater instructions across a plurality of smart phones.

6. The method and application of claim 5 wherein the app is used to create participatory theater where the users each wear headsets and hear their lines, stage direction and inner thoughts through the headsets.

7. The method and application of claim 1 wherein the app syncs storytelling audio across a plurality of smart phones.

8. The method and application of claim 7 wherein the app syncs storytelling audio across a user's smart phone, one or more stuffed animals each with integrated devices to receive discrete scripted audio, and a separate director's device to receive discrete scripted audio.
